(19) United States
(12) Patent Application Publication
(10) Pub. No.: US 2015/0066988 A1
(43) Pub. Date: Mar. 5, 2015

(54) SCALABLE PARALLEL SORTING ON MANYCORE-BASED COMPUTING SYSTEMS

(71) Applicant: NEC Laboratories America, Inc., Princeton, NJ (US)

(72) Inventors: Srihari Cadambi, Princeton Junction, NJ (US); Srimat Chakradhar, Manalapan, NJ (US); Yuan Yuan, Princeton, NJ (US)

(21) Appl. No.: 14/472,752

(22) Filed: Aug. 29, 2014

Related U.S. Application Data
(60) Provisional application No. 61/871,960, filed on Aug. 30, 2013.

(51) Int. Cl. G06F 17/30

(52) U.S. Cl. CPC G06F 17/30961; G06F 17/30194
USPC 707/797

(57) ABSTRACT

Systems and methods for sorting data, including chunking unsorted data such that each chunk is of a size that fits within a last level cache of the system. One or more threads are instantiated in each physical core of the system, chunks assigned physical cores are distributed evenly across the threads on the physical cores. Subchunks in the physical cores are sorted using vector intrinsics, the subchunks being data assigned to the threads in the physical cores, and the subchunks are merged to generate sorted large chunks. A binary tree, which includes leaf nodes that correspond to the sorted large chunks, is built, leaf nodes are assigned to threads, and tree nodes are assigned to a circular buffer, wherein the circular buffer is lock and synchronization free. The large chunks are sorted to generate sorted data as output.

### RELATED APPLICATION INFORMATION

This application claims priority to provisional application Ser. No. 61/871,960 filed on Aug. 30, 2013, incorporated herein by reference in its entirety,

### BACKGROUND

1. Technical Field the present invention relates to sorting data and more specifically to scalable parallel sorting on manycore-based computing systems.

2. Description of the Related Art

Sorting data is a fundamental problem in the field of computer science, and as computing systems become more parallel, sorting methods that scale with hardware parallelism will become indispensable for a variety of applications. Sorting is generally performed using well established methods (e.g., quicksort, merge-sort, radix sort, etc.). Several efficient, parallel implementations of these methods exist, but these existing parallel methods require synchronization between parallel threads. Such synchronization is detrimental to performance scalability as the parallelism, or the number of threads, increases.

In addition, these parallel algorithms do not carefully chunk data in order to match processor cache sizes and increase data locality (and avoid the slow external memory accesses), which can lead to performance degradation problems. As such, there is a need for an efficient and scalable sorting system and method which overcomes the above-mentioned issues.

### SUMMARY

A method for sorting data, including chunking unsorted data using a processor, such that each chunk is of a size that fits within a last level cache of the system; instantiating, one or more threads in each physical core of the system, and distributing chunks assigned to the physical cores evenly across the one or more threads on the physical cores; and sorting subchunks in the physical cores using vector intrinsics, the subchunks being data assigned to the one or more threads in the physical cores. The subchunks are merged to generate sorted large chunks, and a binary tree, which includes one or more leaf nodes that correspond to each of the sorted large chunks, is built. One or more leaf nodes are assigned to the one or more threads, and each of one or more tree nodes is assigned to a circular buffer, wherein the circular buffer is lock and synchronization free. The sorted large chunks are merged to generate sorted data as output.

A manycore-based system for sorting data, including a chunking module configured to chunk unsorted data, such that each chunk is of a size that fits within a last level cache of the system; an instantiation module configured to instantiate one or more threads in each physical core of the system, and to distribute chunks assigned to the physical cores evenly across the one or more threads on the physical cores; and a sorting module configured to sort subchunks in the physical cores using vector intrinsics, the subchunks being data assigned to the one or more threads in the physical cores. A merging module is configured to merge the subchunks to generate sorted large chunks, and to build a binary tree which includes one or more leaf nodes that correspond to each of the sorted large chunks; and an assignment module is configured to assign the one or more leaf nodes to the one or more threads, and to assign each of one or more tree nodes a circular buffer, wherein the circular buffer is lock and synchronization free. A large chunk merging module is configured to merge the sorted large chunks to generate sorted data as output.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a method for parallel sorting for computer systems in accordance with one embodiment of the present principles;

FIG. 2 is a block/flow diagram showing a method for vectorized sorting in accordance with one embodiment according to the present principles;

FIG. 3 is a block/flow diagram showing a method for merging sorted chunks in accordance with one embodiment according to the present principles;

FIG. 4 is a block/flow diagram showing a method for merging sorted large chunks in accordance with one embodiment according to the present principles;

FIG. 5 is a block/flow diagram showing a system for scalable parallel sorting on computing systems in accordance with one embodiment according to the present principles; and

FIG. 6 is a block/flow diagram showing a circular buffer in accordance with one embodiment according to the present principles.

### DETAILED DESCRIPTION OF PREFERRED EMBODIMENTS

In accordance with the present principles, systems and methods for sorting data are provided. In one embodiment systems and methods for scalable parallel sorting on manycore-based computing systems (e.g., multi-socket systems including several commodity multi-core processors, systems including manycore processors, etc.) are illustratively depicted in accordance with the present principles. The present principles may implement a parallel implementation of sorting methods (e.g., mergesort), and may be tailored to manycore processing systems.

The system and method according to the present principles may include lock-free buffers and may include a method to ensure that threads generally remain busy while using no locks. It is noted that although the system and method locks may be employed at certain times (e.g., between major stages). The present principles also may be applied to chunk data in a manner in which most data is cached, thereby minimizing off-chip memory accesses. Thus, the present principles may be employed to achieve significant improvement in operation speeds for applications that use sorting when compared to currently available sorting systems and methods.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

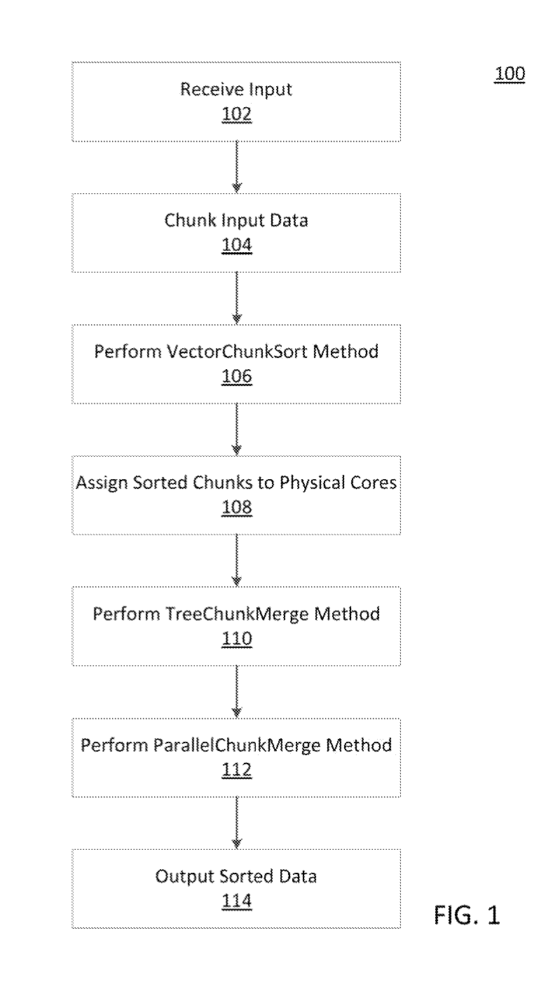

Referring now to the drawings in which like numerals represent the same or similar elements and initially to FIG. 1, a method for parallel sorting for computer systems (e.g., manycore systems) 100 is illustratively depicted in one embodiment according, to the present principles. In one embodiment, input data (e.g., unsorted data) of size M bytes may be received in block 102, and the data may be chunked in block 104. The input data may be chunked in a manner such that each chunk fits within the last level cache (LLC) of the system (e.g., manycore system). It is noted that an LLC may be a shared highest-level cache, which may be called before accessing memory.

The chunks may be a plurality of sizes. For example, in one embodiment, for a chunk size C, the cache size may also be C. In another embodiment, if the cache size is C, then M/C sorted chunks may be generated in block 104. In yet another embodiment, the chunk size C may be equal to the last level cache size multiplied by at integer (e.g., the number of physical processing cores p), or may be of a size set by an end user when chunking the input data in block 104. Each chunk may be sorted by all the processing cores p in parallel using a vectorized sorting method according to the present principles (hereinafter “VectorChunkSort”) in block 106, and the sorted chunks may be stored in memory.

In one embodiment, the sorted chunks may be assigned and distributed evenly across the p physical cores of a manycore system in block 108. Each physical core p may merge its sorted chunks within each core using a merging method according to the present principles (hereinafter “TreeChunkMerge.”) in block 110. After the TreeChunkMerge, there may be exactly P sorted larger chunks (e.g., larger than the non-merged chunks) in memory, where P is the number physical cores, and the P larger chunks may be sorted using a parallel chunk sorting method according to the present principles (hereinafter “ParallelChunkMerge”) in block 112. Sorted data (e.g., M bytes of sorted data) may be output in block 114. It is noted that the methods according to the present principles for VectorChunkSort, TreeChunkMerge, and ParallelChunkMerge will be discussed in further detail hereinbelow.

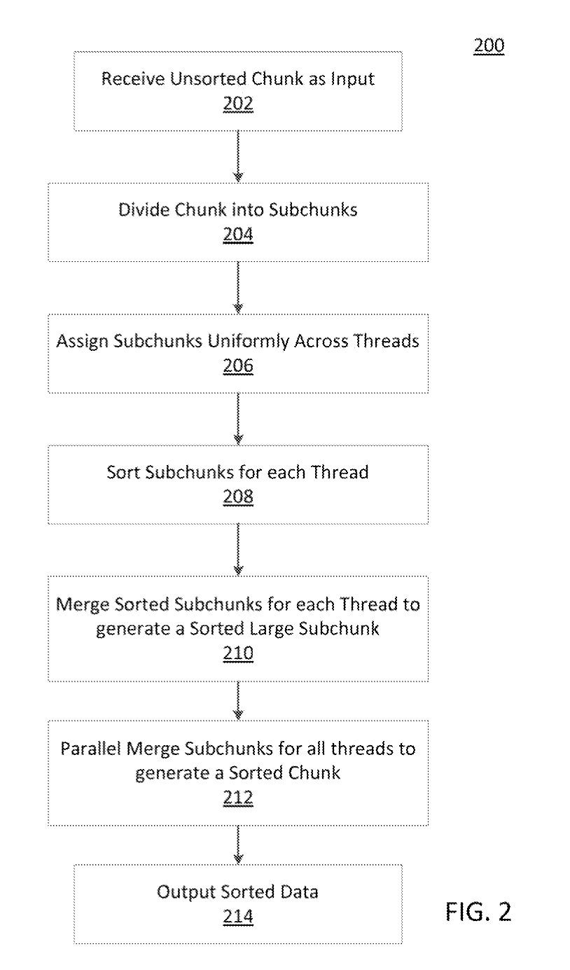

Referring now to FIG. 2, a vectorized sorting method according to the present principles (VectorChunkSort) 200 is illustratively depicted in accordance with one embodiment of the present principles. In one embodiment, the VectorChunkSort method according to the present principles may sort a chunk using all cores in at manycore system. The chunk may first be divided into subchunks in block 204, and each of the chunks may be the size of the vector for the system. A specified number of threads T may be instantiated in each physical core (e.g., by affinitizing), and the subchunks may be evenly distributed among all threads in block 206. It is noted that in one embodiment, subchunks are data assigned to the specified number of threads T in each physical core.

In one embodiment, each thread may sort and merge its subchunks using, for example, vector intrinsics, to produce as many larger subchunks as threads in the system. For example, each thread may vector-sort each of its subchunks in block 208, and each thread may vector merge its sorted subchunks to produce a sorted large subchunk in block 210. Next, all threads may parallel merge the subchunks to produce the sorted chunk in block 212 (e.g., P*T threads may parallel merge P*T large sorted subchunks, were P is the number of physical cores, and T is the number of threads per physical core). Sorted data (e.g., sorted chunk) may be output in block 214, and the sorted chunk may be of size, for example, P* last level cache size, where P is the number of physical cores.

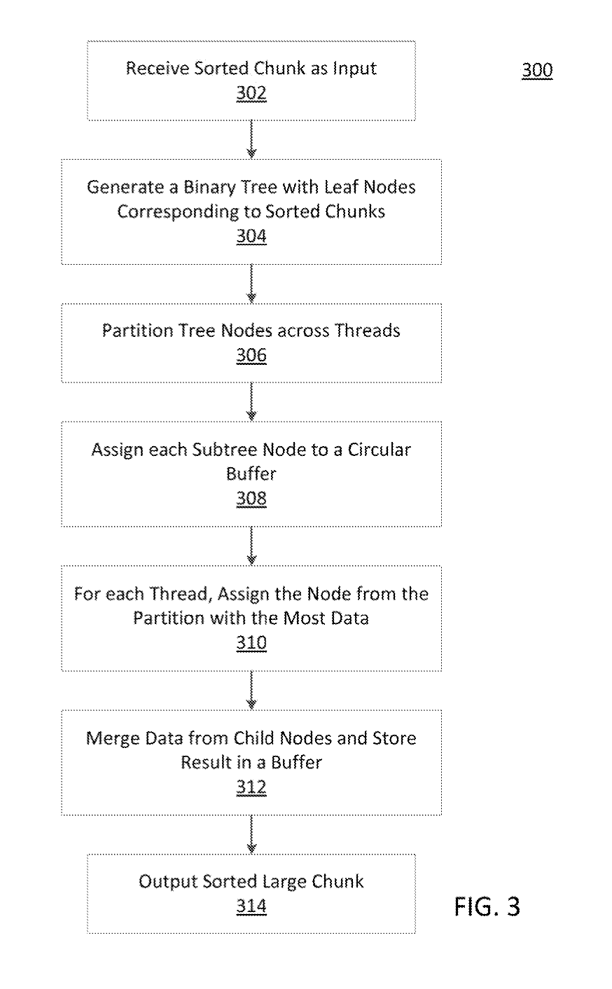

Referring now to FIG. 3, a method of merging, sorted chunks (e.g., within each core of a manycore system) (TreeChunkMerge) 300 is illustratively depicted in accordance with one embodiment of the present principles. In one embodiment, sorted chunks may be received as input in block 302, and T threads may be instantiated in one or more cores. A binary tree with leaf nodes corresponding to sorted chunks to be merged may be generated in block 304. There may be fewer threads than nodes in this phase. Each thread may be assigned (e.g., statically) a specific set of nodes, and tree nodes may be partitioned across threads in block 306 by assigning nodes to threads in a round robin manner. Each node (e.g., subtree node, tree node, etc.) may be assigned to a circular buffer in block 308, and the size of all buffers may be less than the cache size of the core.

In one embodiment, a data quantum size Q1 may be set for each thread, and a node may be assigned from the partition that contains the most amount of data in block 310. Then, for each node, if both child nodes have at least Q1 bytes of data and their parent has Q1 bytes of space, the children's data may be merged and stored in the circular buffer in block 312, and a sorted large chunk may be output in block 314.

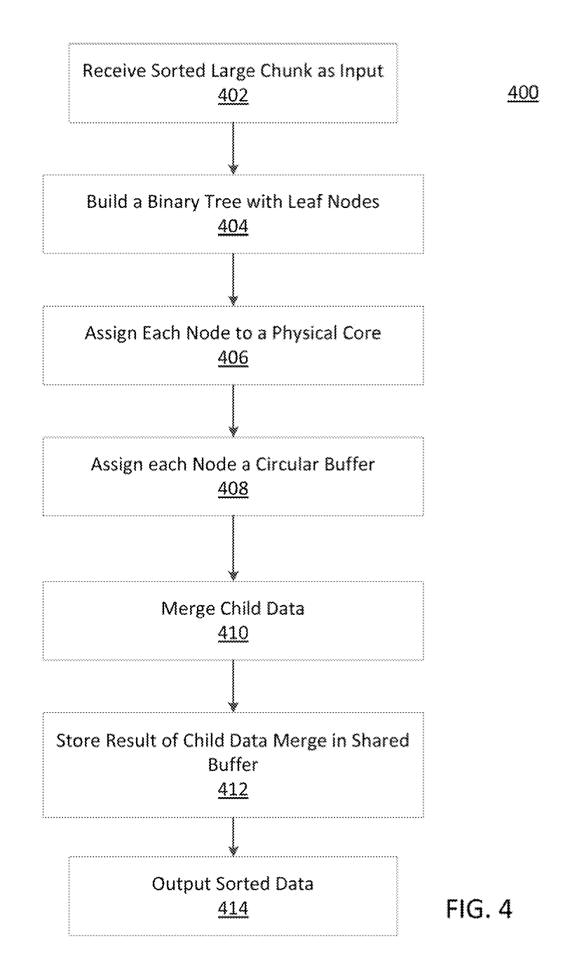

Referring now to FIG. 4, a method of merging sorted large chunks (e.g., within a manycore system (ParallelChunkMerge) 400 is illustratively depicted according to the present principles. In one embodiment, a difference between ParallelChunkMerge and TreeChunkMerge is that ParallelChunkMerge is a final merging of P larger chunks by P cores, and in ParallelChunkMerge, there may be exactly as many nodes as threads (e.g., cores), and in one embodiment, threads may not need to be assigned different nodes during ParallelChunkMerge.

In one embodiment, a sorted large chunk may be received as input in block 402. A binary tree with leaf nodes may be built in block 404, and each node may be assigned (e.g., statically) to a physical core in block 406. It is noted that the number of leaf nodes may be equal to the number of sorted large chunks to be merged, which may also equal the number of physical cores. Each node may be assigned to a circular buffer in block 408, and the total size of the buffers may be the number of processing cores p* last level cache size. For each node, if both children have, for example, Q2 bytes of data, and there is Q2 bytes of space in its circular buffer, children's data may be merged in block 410, and the result of the child data merge may be stored in the circular buffer (e.g., shared circular buffer) in block 412. The sorted data (e.g., M bytes) may be output in block 414. It is noted that although one thread and one chunk per physical core are illustratively depicted, it is contemplated that other sorts of configurations may be employed according to the present principles.

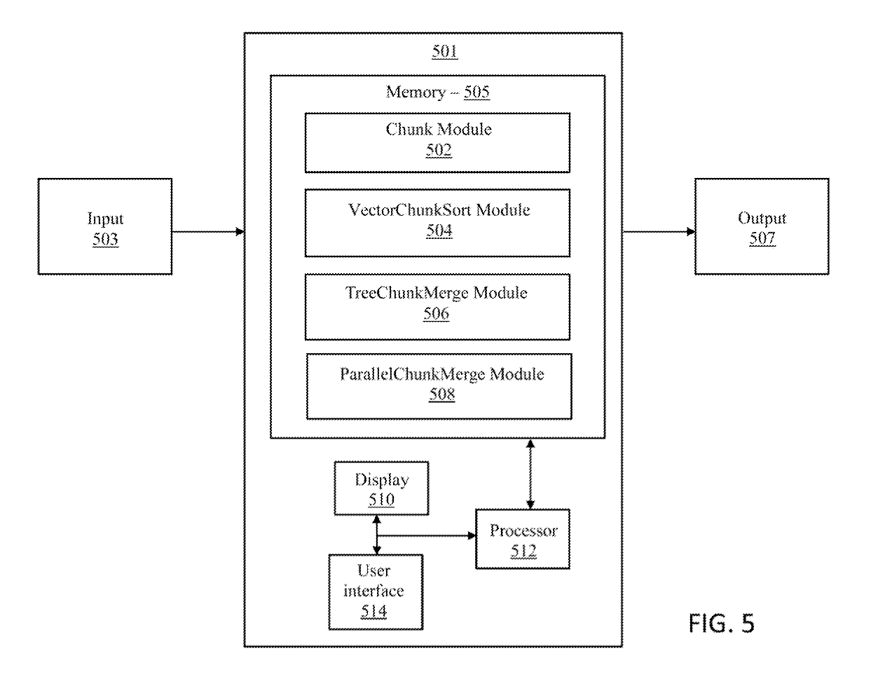

Referring now to FIG. 5, a system for scalable parallel sorting on computing systems (e.g., manycore systems) 501 is illustratively depicted according to the present principles. It one embodiment, the system 501 includes one or more processors 512 and memory 505 for storing applications, modules and other data. The system 501 may include one or more displays 510 for viewing. The displays 510 may permit a user to interact with the system 501 and its components and functions. This ma be further facilitated by a user interface 514, which may include a mouse, joystick, or any other peripheral or control to permit user interaction with the system 501 and/or its devices. It should be understood that the components and functions of the system 501 may be integrated into one or more systems or workstations.

The system 501 may receive input data 503 which may be employed as input to a plurality of modules, including a chunk module 502, a VectorChunkSort module 504, a TreeChunkMerge modulo 506, and a ParallelChunkMerge module 508, which may be configured to perform a plurality of tasks, including, but not limited to receiving data, chunking data, instantiating threads, sorting and merging chunks and subchunks, caching data, and buffering. The system 501 may produce output data 507, which in one embodiment may be displayed on one or more display devices 510. It should be noted that while the above configuration is illustratively depicted, it is contemplated that other sorts of configurations may also be employed according to the present principles.

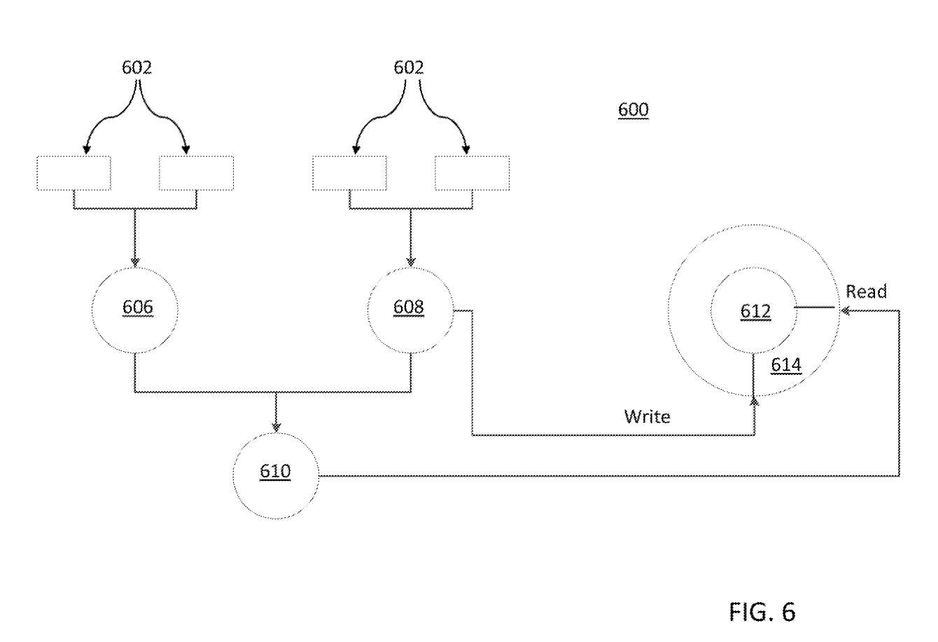

Referring now to FIG. 6, block/flow diagram of a system including a circular buffer and tree 600 is illustratively depicted in accordance with one embodiment according to the present principles. In one embodiment, nodes 602 are children of threads 606 and 608, where thread 608 writes to a circular buffer 612. Thread 610 may read from the circular buffer 612, with available data in the circular buffer in block 614. The circular buffer may be lock free, and may not employ synchronization (e.g., only one thread writes to it, while only one thread reads from it) in one embodiment.

In one embodiment, the present principles employ a tree based parallel merge with synchronization free data structures, and tree nodes May be allocated to threads during merging. The tree-based parallel merging system and method may employ shared data structures, and may manage the size of the shared data structures by considering the manycore caches of the manycore systems. It is noted that the synchronization free parallel merging according to the present principles may be highly scalable for sorting as the system becomes more parallel, and the merging may be performed while avoiding off-chip memory access when employing a circular buffer 612.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for sorting, data, comprising:
chunking unsorted data using, a processor, such that each chunk is of a size that fits within a last level cache of the system;
instantiating one or more threads in each physical core of the system, and distributing chunks assigned to the physical cores evenly across the one or more threads in the physical cores;
sorting subchunks in the physical cores using vector intrinsics, the subchunks being data assigned to the one or more threads in the physical cores;
merging the subchunks to generate sorted large chunks, and building a binary tree which includes one or more leaf nodes that correspond to each of the sorted large chunks;
assigning the one or more leaf nodes to the one or more threads, and assigning each of one or more tree nodes a circular buffer, wherein the circular buffer is lock and synchronization free; and
merging the sorted large chunks to generate sorted data as output.

2. The method as recited in claim 1, wherein the chunking the unsorted data caches a majority of the unsorted data to minimize off-chip memory access.

3. The method as recited in claim 1, wherein the each of one or more tree nodes is assigned to a different circular buffer.

4. The method as recited in claim 1, wherein the assigning of the one or more leaf nodes is performed in a round-robin manner.

5. The method as recited in claim 1, wherein a size of all the circular buffers is less than a cache size of the each physical core.

6. The method as recited in claim 1, wherein the one or more leaf nodes is statically assigned to the one or more threads.

7. The method as recited in claim 1, wherein the merging the subchunks is performed by parallel merging the subchunks.

8. The method as recited in claim 1, wherein the merging the subchunks to generate sorted large chunks generates one large chunk for each of the physical cores.

9. A manycore-based system for sorting data, comprising:
a chunking module configured to chunk unsorted data, such that each chunk is of a size that fits within a last level cache of the system;
an instantiation module configured to instantiate one or more threads in each physical core of the system, and to distribute chunks assigned to the physical cores evenly across the one or more threads in the physical cores;
a sorting module configured to sort subchunks in the physical cores using vector intrinsics, the subchunks being data assigned to the one or more threads in the physical cores;
a merging module configured to merge the subchunks to generate sorted large chunks, and to build a binary tree which includes one or more leaf nodes that correspond to each of the sorted large chunks;
an assignment module configured to assign the one or more leaf nodes to the one or more threads, and to assign each of one or more tree nodes a circular buffer, wherein the circular buffer is lock and synchronization free; and
a large chunk merging module, configured to merge the sorted large chunks to generate sorted data as output.

10. The system as recited in claim 9, wherein the chunking the unsorted data caches a majority of the unsorted data to minimize off-chip memory access.

11. The system as recited in claim 9, wherein the each of one or more tree nodes is assigned to a different circular buffer.

12. The system as recited in claim 9, wherein the assigning of the one or more leaf nodes is performed in a round-robin manner.

13. The system as recited in claim 9, wherein a size of all the circular buffers is less than a cache size of the physical core.

14. The system as recited in claim 9, wherein the one or more leaf nodes is statically assigned to the one or more threads.

15. The system as recited in claim 9, wherein the merging the subchunks is performed by parallel merging the subchunks.

16. The system as recited in claim 9, wherein the merging the subchunks to generate sorted large chunks generates one large chunk for each of the physical cores.
